(19) United States
(12) Patent Application Publication
(10) Pub. No.: US 2026/0281191 A1
(43) Pub. Date: Sep. 17, 2026

(54) METHOD, APPARATUS, DEVICE AND STORAGE MEDIUM FOR MANAGING A CLIENT

(71) Applicant: Bytedance Technology Ltd., Grand Cayman (KY)

(72) Inventors: Jian TIAN, Culver City, CA (US); Fan HU, Beijing (CN); Ziwen SUN, Beijing (CN); Peisen JIN, Culver City, CA (US); Jingyu NIU, Beijing (CN)

(21) Appl. No.: 19/183,267

(22) Filed: Apr. 18, 2025

(30) Foreign Application Priority Data
Mar. 11, 2025 (CN) 202510287983.X

(51) Int. Cl. H04L 67/50; H04L 67/00

(52) U.S. Cl. CPC H04L 67/50; H04L 67/34

(57) ABSTRACT

According to embodiments of the disclosure, methods, apparatuses, devices, and storage media for managing a client are provided. The method includes: sending, by a client, a first request to a server in response to the client being started for the first time at an electronic device, the first request indicating a device identification associated with the electronic device; receiving version information from the server, the version information indicating a target experimental version to be run by the client, wherein the target experimental version is determined based on the device identification and experimental configuration information, and the experimental configuration information indicates conditions corresponding to different experimental versions of the client; and running, at the electronic device, the target experimental version of the client.

### CROSS-REFERENCE

This application claims priority to Chinese Application No. 202510287983.X, filed on Mar. 11, 2025 and entitled ‘METHOD, APPARATUS, DEVICE AND STORAGE MEDIUM FOR MANAGING A CLIENT’, which is incorporated herein by reference in its entirety.

### FIELD

Example embodiments of the present disclosure generally relate to the field of computers, and in particular, to methods, apparatuses, devices, and computer-readable storage media for managing a client.

### BACKGROUND

Experimental version allocation refers to a process of allocating a user request or traffic to different experimental versions based on a predefined strategy when performing an experiment or a test. Its core purpose is to optimize system performance through a reasonable allocation strategy, improve user experience, or perform scientific experiment verification.

### SUMMARY

In a first aspect of the present disclosure, a method for managing a client is provided. The method includes: sending, by a client, a first request to a server in response to the client being started for the first time at an electronic device, the first request indicating a device identification associated with the electronic device; receiving version information from the server, the version information indicating a target experimental version to be run by the client, where the target experimental version is determined based on the device identification and experimental configuration information, and the experimental configuration information indicates conditions corresponding to different experimental versions of the client; and running, at the electronic device, the target experimental version of the client.

In a second aspect of the present disclosure, an apparatus for managing a client is provided. The device includes: a sending module configured to send, by a client, a first request to a server in response to the client being started for the first time at an electronic device, the first request indicating a device identification associated with the electronic device; a receiving module configured to receive version information from the server, the version information indicating a target experimental version to be run by the client, where the target experimental version is determined based on the device identification and experimental configuration information, and the experimental configuration information indicates conditions corresponding to different experimental versions of the client; and a running module configured to run, at the electronic device, the target experimental version of the client.

In a third aspect of the present disclosure, an electronic device is provided. The device includes: at least one processing unit; and at least one memory coupled to the at least one processing unit and storing instructions for execution by the at least one processing unit, the instructions, when executed by the at least one processing unit, causing the electronic device to perform the method of the first aspect.

In a fourth aspect of the present disclosure, a computer-readable storage medium is provided. The computer-readable storage medium has a computer program stored thereon, the computer program, when executed by a processor, implementing the method of the first aspect.

In a fifth aspect of the present disclosure, a computer program product is provided. The computer program product includes computer-executable instructions, where the computer-executable instructions, when executed by a processor, implement the method of the first aspect of the present disclosure.

It would be appreciated that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, where:

FIG. 1 illustrates a schematic diagram of an example environment in which embodiments of the present disclosure may be implemented;

FIG. 2 illustrates a flowchart of a process of managing a client according to some embodiments of the present disclosure;

FIG. 3 illustrates a system flow diagram of managing a client according to some embodiments of the present disclosure;

FIG. 4 illustrates a schematic structural block diagram of an apparatus for managing a client according to some embodiments of the present disclosure;

FIG. 5 illustrates a block diagram of an electronic device capable of implementing various embodiments of the present disclosure.

### DETAILED DESCRIPTION

Embodiments of the present disclosure would be described in more detail below with reference to the accompanying drawings. While certain embodiments of the present disclosure are illustrated in the accompanying drawings, it would be appreciated that the present disclosure may be implemented in various forms and would not be construed as limited to the embodiments set forth herein. Rather, these embodiments are provided for a more thorough and complete understanding of the present disclosure. It would be appreciated that the drawings and embodiments of the present disclosure are for example purposes only and are not intended to limit the scope of the present disclosure.

It would be appreciated that the title of any section/subsection provided herein is not limiting. Various embodiments are described throughout, and any type of embodiments may be included in any section/subsection. Furthermore, the embodiments described in any section/subsection may be combined in any manner with the same section/subsection and/or any other embodiment described in different sections/subsections.

In the description of the embodiments of the present disclosure, the terms ‘including’ and the like would be understood to include ‘including but not limited to’. The term ‘based on’ would be understood as ‘based at least in part on’. The terms ‘one embodiment’ or ‘the embodiment’ would be understood as ‘at least one embodiment’. The term ‘some embodiments’ would be understood as ‘at least some embodiments’. Other explicit and implicit definitions may also be included below. The terms ‘first,’ ‘second,’ and the like may refer to different or identical objects. Other explicit and implicit definitions may also be included below.

Embodiments of the present disclosure may relate to data of a user, obtaining and/or use of data, and the like. These aspects all follow the corresponding laws and regulations and related regulations. In the embodiments of the present disclosure, all data collection, acquisition, processing, handling, processing, reposting, use, and the like are carried out on the premise of the knowledge and confirmation of the user. Accordingly, when implementing the embodiments of the present disclosure, the types of the data or information that may be involved, the usage scope, the usage scenario, and the like would be notified to the user and obtain the authorization of the user in an appropriate manner according to the relevant laws and regulations. The specific notification and/or authorization manner may vary according to actual situations and application scenarios, and the scope of the present disclosure is not limited in this respect.

According to the solutions in the present specification and the embodiments, for example, personal information processing is involved, processing may be performed on the premise of having a legality basis (for example, obtaining consent of a personal information subject, or necessary for performing a fulfillment contract), and processing only within a specified or agreed range. The user rejects personal information other than necessary information required by the basic function and may not affect the basic function of the user.

Conventionally, a client local traffic splitting experiment refers to a rapid allocation of experimental versions being performed on a client locally, that is, a user traffic splitting operation, without relying on a server. However, since the allocation process of the experimental version is completed on the client, there is a lack of systematic control over the traffic splitting nodes, which leads to problems such as inconvenient traffic control and the inability to close the experiment.

The embodiment of the present disclosure provides a scheme for managing a client. According to the scheme, a first request to a server is sent by a client, in response to the client being started for the first time at an electronic device, the first request indicating a device identification associated with the electronic device; version information is received from the server, the version information indicating a target experimental version to be run by the client, where the target experimental version is determined based on the device identification and experimental configuration information, and the experimental configuration information indicates conditions corresponding to different experimental versions of the client; and the target experimental version of the client is run at the electronic device.

Based on this manner, the embodiments of the present disclosure may perform data transmission between the client and the server, so that the server may systematically control the overall experimental version allocation process, to improve accuracy of experimental version allocation.

### Example Environment

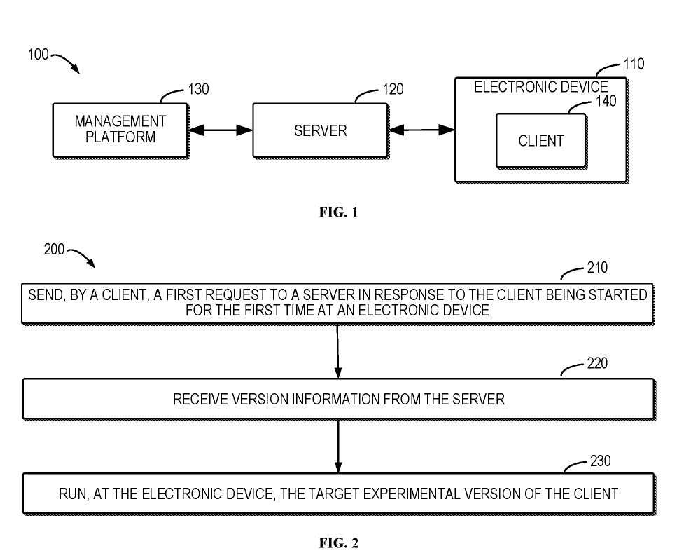

FIG. 1 illustrates a schematic diagram of an example environment 100 in which embodiments of the present disclosure may be implemented. As illustrated in FIG. 1, the example environment 100 may include an electronic device 110, a server 120, and a management platform 130.

In this example environment 100, a client 140 may be run on the electronic device 110. The client 140, in contrast to the server 120, is software used to initiate requests and interact with the server 120.

In some embodiments, the electronic device 110 communicates with the server 120 to enable provisioning of services to the application 120. The electronic device 110 may be any type of mobile terminal, fixed terminal, or portable terminal with a display device, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 may also support any type of interface for a target user (such as a “wearable” circuit, etc.).

The server 120 may be a standalone physical server, or may be a server cluster or a distributed system composed of a plurality of physical servers, or may be a cloud server that provides basic cloud computing services such as cloud services, cloud databases, cloud computing, cloud computing, cloud functions, cloud storage, network services, cloud communications, middleware services, domain name services, security services, content distribution networks, big data and artificial intelligence platforms. The server 120 may include, for example, a computing system/server, such as a mainframe, an edge computing node, a computing device in a cloud environment, or the like. The server 120 may provide background services for applications 120 that support interface interaction in the electronic device 110.

A communication connection may be established between the server 120 and the electronic device 110. The communication connection may be established in a wired manner or a wireless manner. The communication connection may include, but is not limited to, a Bluetooth connection, a mobile network connection, a Universal Serial Bus (USB) connection, a Wireless Fidelity (Wi-Fi) connection, and the like, and the embodiments of the present disclosure are not limited in this aspect. In an embodiment of the present disclosure, the server 120 and the electronic device 110 may implement signaling interaction through a communication connection therebetween.

The management platform 130 is an informatization platform for managing and optimizing experimental procedures, which may implement comprehensive management and regulation of experimental full-flow, and aims to improve experimental efficiency, specification experimental flow and guarantee data security through digital means, and provide convenient tool support for experimenters and managers. The management platform 130 interacts with the electronic device 110 through the server 120, the user may access the management platform 130 via the server 120 through the electronic device 110, send a request. After receiving the request, the server 120 sends a corresponding request to the management platform 130, so that the management platform 130 can perform information processing, and feedback the result to the electronic device 110 through the server 120.

It would be appreciated that the structures and functions of the various elements in the environment 100 are described for example purposes only and do not imply any limitation to the scope of the present disclosure.

Some example embodiments of the present disclosure will be described below with continued reference to the accompanying drawings.

### Example Process

FIG. 2 illustrates a flowchart of a process 200 of managing a client according to some embodiments of the present disclosure. The process 200 is described below with reference to FIG. 1.

At block 210, in response to the client being started for the first time at an electronic device, a first request is sent by a client to a server.

In some embodiments, user traffic splitting refers to a process of allocating user requests or traffic to different processing paths or experimental versions according to a predefined rule. The core purpose is to optimize system performance, improve user experience, support function iteration, or perform scientific experiment verification through a reasonable allocation strategy.

In some embodiments, the first request indicates a device identification associated with the electronic device 110. The device identification uniquely recognizes the electronic device 110 by using a specific tag, symbol, or code, for example, the device identification may include a device ID corresponding to the electronic device 110.

In some embodiments, starting for the first time means that the client 140 is opened and running for the first time on the electronic device 110, for example, the client 140 may be a target application, and starting for the first time may indicate that the target application is started for the first time after the user downloads and installs the target application. Starting for the first time may also indicate that the user has previously downloaded the target application but later uninstalled it, and then the user starts the target application for the first time after re-downloading and installing the target application again.

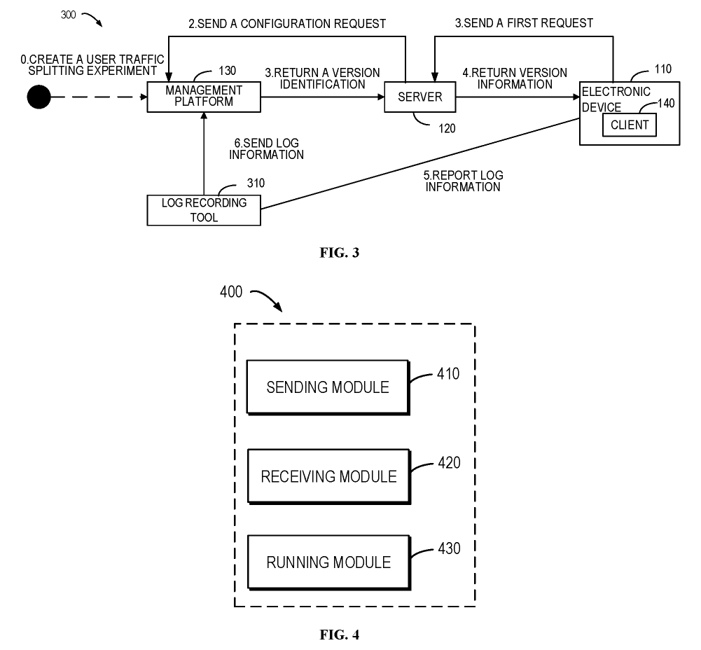

In some embodiments, the client 140 may invoke a predetermined interface provided by the server 120, and send the first request to the server 120. For example, as shown in FIG. 3, when it is detected that the client 140 is started for the first time at the electronic device 110, the client 140 may request an interface of the server 120 and send a first request to the server 120. The server 120 may then receive the first request from the client 140.

At block 220, the electronic device 110 receives version information from the server 120.

In some embodiments, the version information indicates a target experimental version to be run by the client, where the target experimental version is determined based on the device identification and experimental configuration information, and the experimental configuration information indicates conditions corresponding to different experimental versions of the client 140. For example, if there are currently two experimental versions, an experimental version A and an experimental version B, the client 140 may learn, according to the received version information, whether the target experimental version allocated to the client 140 by the management platform 130 is the experimental version A or the experimental version B. This target experimental version is determined by the management platform 130 based on the device identification and the experimental configuration information. The experimental configuration information indicates conditions corresponding to different experimental versions of the client 140, that is, an allocation strategy of the experimental version.

In some embodiments, the experimental versions refer to different statuses or configurations of experimental objects designed to verify certain assumptions, test new functions, or optimize existing systems during the experiment. For example, an experimental version may be applied in an A/B test, and the A/B test is an experimental method for comparing two or more versions of user experiences, functions, or designs to determine which version performs better on a particular metric. For example, the experimental version A may displaying a first interface on a client interface after the user starts the client for the first time, and the button in the first interface is disposed at the top of the interface; and the experiment version B may displaying a second interface on the client interface after the user starts the client for the first time, the button in the second interface is disposed at the bottom of the interface, and after the corresponding experimental versions are allocated to different users, feedbacks of different users for the corresponding experimental versions may be obtained for subsequent decision-making.

In some embodiments, the server 120 is configured to send, in response to receiving the first request from the client 140, a configuration request to a management platform 130, the configuration request at least indicating the device identification. A version identification is then received from the management platform 130, the version identification corresponding to the target experimental version determined by the management platform based on the device identification and the experimental configuration information. Then the version information indicating the version identification is sent to the electronic device 110.

For example, as shown in FIG. 3, after receiving the first request from the client 140, the server 120 invokes the device identification associated with the electronic device 110 as carrying information, invokes the interface of the management platform 130, and sends a configuration request to the management platform 130. Then, after receiving the version identification from the management platform 130, the server 120 generates version information based on the version identification, and sends the version information to the electronic device 110. With this method, it is possible to configure the experimental program and view the experimental data independently.

In some embodiments, the management platform 130 is configured to determine, in response to receiving the configuration request, the target experimental version matching the device identification from a set of experimental versions of the client 140. Then, the version identification corresponding to the target experimental version is sent to the server 120. For example, as shown in FIG. 3, after receiving the configuration request from the server 120, the management platform 130 determines which experimental version to allocate to the electronic device 110 from a set of experimental versions of the client 140, that is, the experimental version A and the experimental version B, based on the device identification carried in the configuration request. Then, the version identification corresponding to the target experimental version is sent to the server 120. With this method, systematic control of the traffic splitting nodes can be achieved in order to significantly improve the performance and stability of the system, as well as to reduce the cost and complexity of operation and maintenance.

In some embodiments, the management platform 130 may obtain the experimental configuration information indicating device identification features corresponding to the different experimental versions, then determine, based on the device identification, the target experimental version from the set of experimental versions, the target experimental version matching a target identification feature of the received device identification. For example, the management platform 130 may obtain experimental configuration information, where the experimental configuration information indicates what device identification features correspond to the experimental version A and the experimental version B. Then, the management platform 130 may perform a feature matching with the device identification feature indicated in the experimental configuration information based on the target identification feature of the received device identification, and finally determine the target experimental version from the experimental version A and the experimental version B.

In some embodiments, the embodiments of the present disclosure may deliver the result in a separate interface, and in this way, the management platform 130 may better satisfy the needs of users for data security, system performance, and user experience, while facilitating the long-term maintenance and expansion of the system.

In some embodiments, the management platform 130 is further configured to log information from the client, the log information indicating the version identification of the target experimental version that the client runs. For example, as shown in FIG. 3, a log recording tool 310 may obtain log information from the client 140, and send the log information to the management platform 130, so that the management platform 130 performs data monitoring based on the obtained log information. Herein, the log recording tool may be configured to record log information.

With this method, a data monitoring system can be constructed during the entire user traffic splitting process, so that various problems that may occur during user traffic splitting may be investigated through timely detection, anomaly detection, and policy enforcement, etc. Moreover, in the uninstallation and reinstallation scenarios, this method may also be used to avoid the problem of string grouping under the prerequisite of guaranteeing the uniformity of traffic splitting results.

In some embodiments, the log information may be controlled by the client 140. For example, in order to improve the accuracy of the log information exposure, exposure of log information may be performed after the user has actually experienced the function allocated to the target experimental version in order to increase the reliability of the experimental data.

In some embodiments, the management platform 130 may be merged with the server 120, and functions of the server 120 and the management platform 130 may be implemented by using an integrated server. In addition, the management platform 130 may be deployed at a device external to the server 120, so that the server 120 may directly perform client management by using the already deployed management platform 130. For example, the management platform 130 includes a relatively stable traffic splitting service platform that has been deployed, and includes some systematic platform capabilities.

At block 230, a target experimental version of the client is run at the electronic device 110.

In some embodiments, since the target experiment version to be run by the client 140 may be determined based on the version information, the client 140 may run the target experiment version based on the version information. For example, if the target experimental version allocated to the client 140 is the experimental version A, the user may see a first interface on the client interface, and the button in the first interface is placed at the top of the interface; if the target experimental version allocated to the client 140 is the experimental version B, the user may see a second interface on the client interface, and the button in the second interface is placed at the bottom of the interface.

In some embodiments, the method of managing a client of embodiments of the present disclosure may be used within scenarios that focus on the early experience of new users, with new users including users who install and start the client 140 for the first time, and users who reinstall and start the client 140 for the first time. For example, the user downloads and installs a social application, and then after the user starts the social application for the first time, the solution of the embodiments of the present disclosure makes it possible to determine, based on the allocated target experimental version: whether to display an initial interface in the client interface, what content is included in the initial interface, and how to guide the user to authorize the necessary permissions, and so on.

However, if it is necessary to obtain the information about the allocated target experimental version when the client 140 is started, a user traffic splitting operation may be performed locally on the client. For example, if there is a need to obtain information about the allocated target experimental version before the client 140 starts and displays the initial interface, or displays the initial interface, the allocated target experimental version may be determined locally at the client, based on the device identification, and that target experimental version may be run at the client 140.

In some embodiments, in order to avoid closing experiments through time-consuming and labor-intensive means such as version changes, the client 140 may further send a second request to the server 120, and then receive status information from the server 120, the status information indicating whether to close the target experimental version. For example, the client 140 may send a second request to the server 120, and after receiving the second request, the server 120 performs an experiment status query to obtain status information, the status information being used to indicate whether an experiment needs to be started or closed. Then, the server 120 may send the queried status information to the client 140, and if the status information indicates that the experiment needs to be started, the server 120 then continues with the step of sending a configuration request to the management platform 130 by invoking an interface of the management platform 130 with the device identification associated with the electronic device 110 as carrying information as shown in FIG. 3.

For example, the client 140 may store the issued experimental related data, and the client 140 may invoke the interface of the server 120 again. As an example, when the client 140 is cold-started, the client 140 may invoke the interface of the server 120. A cold start refers to starting the client without a process of the client existing in the operating system, such as opening the client after a first installation, or starting the client process again after it has been completely terminated by the system.

If the local storage includes the data related to the experiment that has been traffic split, the server 120 would query and return the experiment status information in real time, and issue an experiment list of whether to close or open the experiment. Closing the experiment in this way not only accurately controls the time point of closing the experiment, but also greatly improves the flexibility of closing the experiment, thus avoiding the traditional way of requiring a version change or a rewrite of the code in order to close the experiment.

In some embodiments, running the target experimental version of the client 140 at the electronic device 110 may be ceased in response to the status information indicating to close the target experimental version. For example, if the status information indicates that the experiment needs to be closed, the target experiment version of running the client 140 at the electronic device 110 is ceased.

The embodiments of the present disclosure can control the overall experiment by introducing the server 120 and the management platform 130, thereby implementing a convenient control for the experiment traffic. By transmitting log information, the purpose of data monitoring is implemented in order to troubleshoot the problem of experiments into groups. The experiment is closed flexibly and quickly by adding an experiment closing mechanism. Application of the embodiments of the present disclosure can ensure that the same experiment traffic splitting is free of string grouping problems while guaranteeing that the traffic allocation between different experiment versions is independent of each other and evenly distributed. As a result of applying the method of managing a client of the embodiments of the present disclosure, it is possible to make the total elapsed time of the experiment traffic splitting very small, so that the user can enter the experiment before a journey of a new user begins.

### Example Apparatus and Device

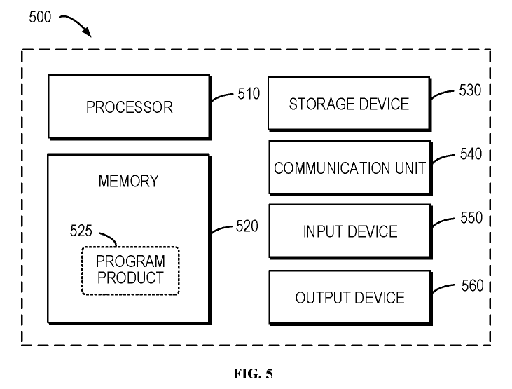

The embodiments of the present disclosure also provide a corresponding apparatus for implementing the above method or process. FIG. 4 illustrates a schematic structural block diagram of an apparatus 400 for managing a client according to some embodiments of the present disclosure. The apparatus 400 may be implemented or included in the electronic device 110 as discussed above. The various modules/components in the apparatus 400 may be implemented by hardware, software, firmware, or any combination thereof.

As shown in FIG. 4, the apparatus 400 includes a sending module 410 configured to send, by a client, a first request to a server in response to the client being started for the first time at an electronic device, the first request indicating a device identification associated with the electronic device; a receiving module 420 configured to receive version information from the server, the version information indicating a target experimental version to be run by the client, where the target experimental version is determined based on the device identification and experimental configuration information, and the experimental configuration information indicates conditions corresponding to different experimental versions of the client; and a running module 430 configured to run, at the electronic device, the target experimental version of the client.

In some embodiments, the server is configured to: send, in response to receiving the first request from the client, a configuration request to a management platform, the configuration request at least indicating the device identification; receive a version identification from the management platform, the version identification corresponding to the target experimental version determined by the management platform based on the device identification and the experimental configuration information; and send, to the electronic device, the version information indicating the version identification.

In some embodiments, the management platform is configured to: determine, in response to receiving the configuration request, the target experimental version matching the device identification from a set of experimental versions of the client; and send, to the server, the version identification corresponding to the target experimental version.

In some embodiments, the management platform is further configured to, obtaining, in response to receiving the configuration request, the experimental configuration information indicating device identification features corresponding to the different experimental versions; determining, based on the device identification, the target experimental version from the set of experimental versions, the target experimental version matching a target identification feature of the received device identification; and send, to the server, the version identification corresponding to the target experimental version.

In some embodiments, the management platform is further configured to obtain log information from the client, the log information indicating the version identification of the target experimental version that the client runs.

In some embodiments, the management platform is deployed at a device external to the server.

In some embodiments, the apparatus 400 further includes a second request sending module 440 configured to send, by the client, a second request to the server; and receive status information from the server, the status information indicating whether to close the target experimental version.

In some embodiments, the apparatus 400 further includes a disabling module 460 configured to cease, in response to the status information indicating to close the target experimental version, running the target experimental version of the client at the electronic device.

In some embodiments, the sending module 410 is further configured to invoke, by the client, a predetermined interface provided by the server to send the first request to the server.

The units included in the apparatus 400 may be implemented in various manners, including software, hardware, firmware, or any combination thereof. In some embodiments, one or more units may be implemented using software and/or firmware, such as machine-executable instructions stored on a storage medium. In addition to or as an alternative to machine-executable instructions, some or all of the units in the apparatus 400 may be implemented, at least in part, by one or more hardware logic components. By way of example and not limitation, example types of hardware logic components that may be used include field programmable gate arrays (FPGAs), application specific integrated circuits (ASICs), application specific standards (ASSPs), system-on-a-chip (SOCs), complex programmable logic devices (CPLDs), and the like.

FIG. 5 illustrates a block diagram of an electronic device 500 in which one or more embodiments of the present disclosure may be implemented. It would be appreciated that the electronic device 500 illustrated in FIG. 5 is merely example and would not constitute any limitation on the functionality and scope of the embodiments described herein. The electronic device 500 shown in FIG. 5 may be configured to implement the electronic device 110 shown in FIG. 1.

As shown in FIG. 5, the electronic device 500 is in the form of a general-purpose electronic device. Components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor and capable of performing various processes according to programs stored in the memory 520. In multiprocessor systems, multiple processing units execute computer-executable instructions in parallel to improve parallel processing capabilities of electronic device 500.

The electronic device 500 typically includes a plurality of computer storage media. Such media may be any available media accessible to the electronic device 500, including, but not limited to, volatile and non-volatile media, removable and non-removable media. The memory 520 may be volatile memory (e.g., registers, caches, random access memory (RAM)), non-volatile memory (e.g., read-only memory (ROM), electrically erasable programmable read-only memory (EEPROM), flash memory), or some combination thereof. The storage device 530 may be a removable or non-removable medium and may include a machine-readable medium, such as a flash drive, magnetic disk, or any other medium, which may be capable of storing information and/or data (e.g., training data for training) and may be accessed within the electronic device 500.

The electronic device 500 may further include additional removable/non-removable, volatile/non-volatile storage media. Although not illustrated in FIG. 5, a disk drive for reading from or writing to a removable, non-volatile disk (e.g., a ‘floppy disk’) and an optical disk drive for reading from or writing to a removable, non-volatile optical disk may be provided. In these embodiments, each drive may be connected to a bus (not illustrated) by one or more data media interfaces. The memory 520 may include a computer program product 525 having one or more program modules that are configured to perform various methods or actions of various embodiments of the present disclosure.

The communication unit 540 implements communication with other electronic devices via a communication medium. Additionally, the functions of the components of the electronic device 500 may be implemented as a single computing cluster or a plurality of computing machines that are capable of communicating over a communication connection. Thus, the electronic device 500 may use logical connections to one or more other servers, networked personal computers (PCs), or a further network node to operate in a networked environment.

The input device 550 may be one or more input devices, such as a mouse, a keyboard, a tracking ball, and the like. The output device 560 may be one or more output devices, such as a monitor, a speaker, a printer, and the like. The electronic device 500 may also communicate, as desired, via the communication unit 540, with one or more external devices (not illustrated), external devices such as storage devices, display devices, etc., with one or more devices that enable a user to interact with the electronic device 500, or with any device that enables the electronic device 500 to communicate with one or more other electronic devices (e.g., a network card, modem, etc.) to communicate. Such communication may be performed via an input/output (I/O) interface (not illustrated).

According to an example implementation of the present disclosure, there is provided a computer-readable storage medium having computer-executable instructions stored thereon, where the computer-executable instructions are performed by a processor to implement the method described above. According to an example implementation of the present disclosure, there is also provided a computer program product, the computer program product being tangibly stored on a non-transient computer-readable medium and including computer-executable instructions, where the computer-executable instructions are performed by a processor to implement the methods described above.

Aspects of the present disclosure are described herein with reference to flowcharts and/or block diagrams of methods, apparatuses, devices, and computer program products implemented according to the present disclosure. It would be appreciated that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium that causes the computer, programmable data processing apparatus, and/or other devices to function in a particular manner, such that the computer-readable medium storing instructions includes an article of manufacture including instructions to implement aspects of the functions/acts specified in the flowchart and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, function, and operation of possible implementations of systems, methods, and computer program products according to various implementations of the present disclosure. In this regard, each block in the flowchart or block diagram may represent a module, program segment, or part of an instruction that includes one or more executable instructions for implementing the specified logical function. In some alternative implementations, the functions noted in the blocks may also occur in a different sequence than noted in the figures. For example, two consecutive blocks may actually be performed substantially in parallel, which may sometimes be performed in the reverse sequence, depending on the function involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are illustrative, not exhaustive, and are not limited to the implementations disclosed. Many modifications and variations would be apparent to those of ordinary skill in the art without departing from the scope and spirit of the various implementations illustrated. The determination of the terms used herein is intended to best explain the principles of the implementations, practical applications, or improvements to techniques in the marketplace, or to enable others of ordinary skill in the art to understand the various implementations disclosed herein.

What is claimed is:

1. A method for managing a client, comprising:
sending, by a client, a first request to a server in response to the client being started for the first time at an electronic device, the first request indicating a device identification associated with the electronic device;
receiving version information from the server, the version information indicating a target experimental version to be run by the client, wherein the target experimental version is determined based on the device identification and experimental configuration information, and the experimental configuration information indicates conditions corresponding to different experimental versions of the client; and
running, at the electronic device, the target experimental version of the client.

2. The method of claim 1, wherein the server is configured to:
send, in response to receiving the first request from the client, a configuration request to a management platform, the configuration request at least indicating the device identification;
receive a version identification from the management platform, the version identification corresponding to the target experimental version determined by the management platform based on the device identification and the experimental configuration information; and
send, to the electronic device, the version information indicating the version identification.

3. The method of claim 2, wherein the management platform is configured to:
determine, in response to receiving the configuration request, the target experimental version matching the device identification from a set of experimental versions of the client; and
send, to the server, the version identification corresponding to the target experimental version.

4. The method of claim 3, wherein determining the target experimental version matching the device identification from the set of experimental versions of the client comprises:
obtaining the experimental configuration information indicating device identification features corresponding to the different experimental versions; and
determining, based on the device identification, the target experimental version from the set of experimental versions, the target experimental version matching a target identification feature of the received device identification.

5. The method of claim 3, wherein the management platform is further configured to:
obtain log information from the client, the log information indicating the version identification of the target experimental version that the client runs.

6. The method of claim 3, wherein the management platform is deployed at a device external to the server.

7. The method of claim 1, wherein after running the target experimental version of the client, the method further comprises:
sending, by the client, a second request to the server; and
receiving status information from the server, the status information indicating whether to close the target experimental version.

8. The method of claim 7, further comprising:
ceasing, in response to the status information indicating to close the target experimental version, running the target experimental version of the client at the electronic device.

9. The method of claim 1, wherein sending, by the client, the first request to the server comprises:
invoking, by the client, a predetermined interface provided by the server to send the first request to the server.

10. An electronic device, comprising:
at least one processing unit; and
at least one memory coupled to the at least one processing unit and storing instructions for execution by the at least one processing unit, the instructions, when executed by the at least one processing unit, causing the electronic device to perform operations comprising:
sending, by a client, a first request to a server in response to the client being started for the first time at an electronic device, the first request indicating a device identification associated with the electronic device;
receiving version information from the server, the version information indicating a target experimental version to be run by the client, wherein the target experimental version is determined based on the device identification and experimental configuration information, and the experimental configuration information indicates conditions corresponding to different experimental versions of the client; and
running, at the electronic device, the target experimental version of the client.

11. The electronic device of claim 10, wherein the server is configured to:
send, in response to receiving the first request from the client, a configuration request to a management platform, the configuration request at least indicating the device identification;
receive a version identification from the management platform, the version identification corresponding to the target experimental version determined by the management platform based on the device identification and the experimental configuration information; and
send, to the electronic device, the version information indicating the version identification.

12. The electronic device of claim 11, wherein the management platform is configured to:
determine, in response to receiving the configuration request, the target experimental version matching the device identification from a set of experimental versions of the client; and
send, to the server, the version identification corresponding to the target experimental version.

13. The electronic device of claim 12, wherein determining the target experimental version matching the device identification from the set of experimental versions of the client comprises:
obtaining the experimental configuration information indicating device identification features corresponding to the different experimental versions; and
determining, based on the device identification, the target experimental version from the set of experimental versions, the target experimental version matching a target identification feature of the received device identification.

14. The electronic device of claim 12, wherein the management platform is further configured to:
obtain log information from the client, the log information indicating the version identification of the target experimental version that the client runs.

15. The electronic device of claim 12, wherein the management platform is deployed at a device external to the server.

16. The electronic device of claim 10, wherein after running the target experimental version of the client, the operations further comprise:
sending, by the client, a second request to the server; and
receiving status information from the server, the status information indicating whether to close the target experimental version.

17. The electronic device of claim 16, wherein the operations further comprise:
ceasing, in response to the status information indicating to close the target experimental version, running the target experimental version of the client at the electronic device.

18. The electronic device of claim 10, wherein sending, by the client, the first request to the server comprises:
invoking, by the client, a predetermined interface provided by the server to send the first request to the server.

19. A non-transitory computer-readable storage medium having a computer program stored thereon, the computer program, when executed by a processor, performing operations comprising:
sending, by a client, a first request to a server in response to the client being started for the first time at an electronic device, the first request indicating a device identification associated with the electronic device;
receiving version information from the server, the version information indicating a target experimental version to be run by the client, wherein the target experimental version is determined based on the device identification and experimental configuration information, and the experimental configuration information indicates conditions corresponding to different experimental versions of the client; and
running, at the electronic device, the target experimental version of the client.

20. The non-transitory computer-readable storage medium of claim 19, wherein the server is configured to:
send, in response to receiving the first request from the client, a configuration request to a management platform, the configuration request at least indicating the device identification;
receive a version identification from the management platform, the version identification corresponding to the target experimental version determined by the management platform based on the device identification and the experimental configuration information; and
send, to the electronic device, the version information indicating the version identification.
